(19) United States
(12) Patent Application Publication
(10) Pub. No.: US 2013/0156251 A1
(43) Pub. Date: Jun. 20, 2013

(54) UTILITY BAG SPEAKER SYSTEM

(71) Applicant: Matthew D. Noble, Los Angeles, CA (US)

(72) Inventor: Matthew D. Noble, Los Angeles, CA (US)

(21) Appl. No.: 13/330,603

(22) Filed: Dec. 19, 2011

(51) Int. Cl. H04R 1/02

(52) U.S. Cl. 381/387

(57) ABSTRACT

A speaker system for a utility bag includes a mounting platform. The mounting platform includes an audio plug receiving portion. A pair of speakers is connected with the audio plug receiving portion. The mounting platform includes an audio device placement portion that includes a protective cover.

### BACKGROUND

1. Field

The embodiments relate to speaker systems, and in particular to speaker systems for utility bags.

2. Description of the Related Art

Utility bags are used for carrying tools, supplies and accessories for professionals as well as non-professionals. Typical utility bags have the sole purpose of carrying tools and accessories from place to place as desired.

### SUMMARY

One embodiment of the invention includes a speaker system for a utility bag that includes a mounting platform. The mounting platform includes an audio plug receiving portion. A pair of speakers is connected with the audio plug receiving portion. The mounting platform includes an audio device placement portion that includes a protective cover.

Another embodiment of the invention comprises a utility bag including: an audio plug receiving portion; a pair of speakers coupled with the audio plug receiving portion; and an audio device placement portion including a protective cover.

Yet another embodiment of the invention comprises a tool bag comprising: a zipper coupled to a first side and a second side of the tool bag; an integrated speaker system coupled to the first side of the tool bag, the speaker system comprising a self contained platform including: an audio plug receiving portion; a pair of speakers coupled with the audio plug receiving portion; and an audio device placement portion including a protective cover.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a perspective view of a utility bag with a speaker system according to one embodiment of the invention;

FIG. 2 illustrates a perspective view of the utility bag speaker system of FIG. 1 shown with a protective audio device cover in an opened state according to one embodiment of the invention;

FIG. 3 illustrates a front view of a speaker system for a utility bag according to one embodiment of the invention;

FIG. 4 illustrates a bottom view of a speaker system for a utility bag according to an embodiment of the invention; and

FIG. 5 illustrates a circuit diagram for a speaker system for a utility bag according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of utility bag speaker systems, as well as operation and/or component parts thereof. While the following description will be described in terms of utility bag speaker systems and devices for clarity and to place the invention in context, it should be kept in mind that the teachings herein may have broad application to all types of systems, devices and applications.

One embodiment of the invention provides a speaker system for a utility bag that includes a mounting platform. The mounting platform includes an audio plug receiving portion. A wiring harness may be connected to the audio plug receiving portion. A pair of speakers is connected with the audio plug receiving portion. The mounting platform includes an audio device placement portion that includes a protective cover.

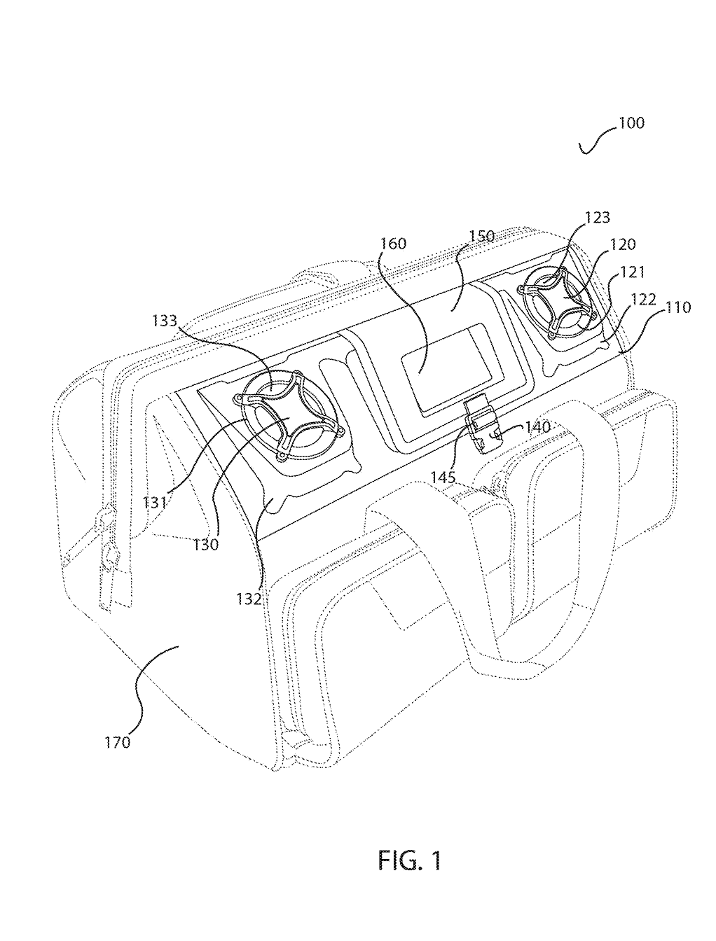

FIG. 1 illustrates a speaker system 100 for a utility bag 170 (e.g., an open/closed tool bag, accessory bag, fishing bag, tackle box, sports accessory bag, sports equipment bags, golf bags, backpacks, luggage, duffel bags, etc.) according to one embodiment of the invention. In one embodiment of the invention, the speaker system 100 includes a pair of speakers 123, 133, and protective cover 150 including a window 160. As illustrated, the protective cover 150 is shown in a closed position/state. In one example, the speaker system 100 is attached to a platform 110 that attaches to an upper sidewall of a utility bag 170. In other examples, the individual components of the speaker system 100 may be directly attached to other portions of the utility bag 170.

In one embodiment of the invention, the speaker system 100 may have more or less than the pair of speakers 123, 133. In one example, an additional subwoofer speaker may be included in speaker system 100. In another example, an additional center speaker and rear speakers may be positioned to provide for surround sound functionality. Other combinations and numbers of speakers may also be included in the speaker system 100, such as only one speaker, three speakers, four speakers, five speakers, etc.

In one embodiment of the invention, the speaker 123 is attached to a mounting platform 122 via a mounting ring 121 and protective guard portion 120; and the speaker 133 is attached to a mounting platform 132 via a mounting ring 131 and protective guard portion 130. In one example, the mounting platforms 122, 132 are molded into the platform 110. In another example, the mounting platforms 122, 132 are separate components that are attached to the utility bag 170 for housing the speakers 123, 133.

In one embodiment of the invention, the mounting platforms 122, 133 and the protective guard portions 120, 130 may be made of one or more of: reinforced polypropylene, polypropylene, high-density polyethylene, nylon material, hardened plastic, polymer, rubber, composite material, metal or metal alloy, etc., or other similar or equivalent materials.

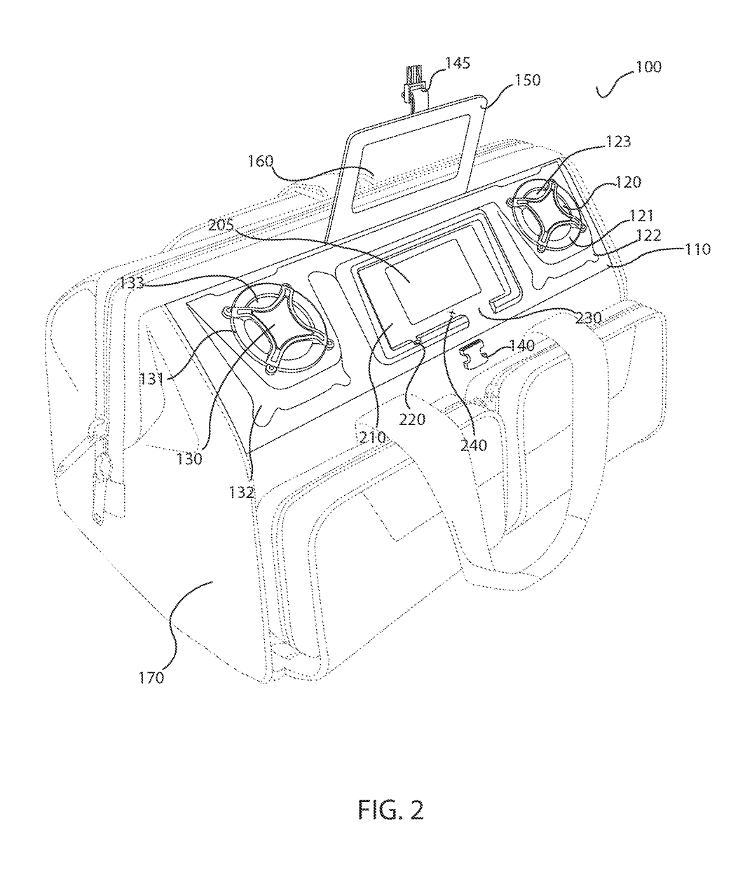

In one embodiment of the invention, the protective cover 150 includes a fastener 145 that removably attaches with a fastener receiver 140. In one example, the fastener 145 snap locks into the fastener receiver 140. In other examples, other fasteners 145 and fastener receivers 140 may be used, such as buckles, snap lock devices, hook and loop fasteners, slide locks, etc. In one example, the protective cover 150 includes a clear or see through window 160 for viewing an audio device (e.g., an MP3 player, compact disc player, a phone, a personal digital assistant, a satellite radio, a radio, etc.) placed in an audio device placement portion 210 (FIG. 2). In one example, the protective cover 150 prevents dust from entering the audio device placement portion 210. In another example, the protective cover 150 prevents water from entering the audio device placement portion 210. In one example, the protective cover 150 may be made of flexible material. In another example, the protective cover 150 may be made of a rigid material. In yet another example, the protective cover 150 may be made of material attached with a see-through window.

In one example, the utility bag 170 may include a zipper that closes/opens two portions of the utility bag. In other examples, the utility bag 170 may be an open top type of tool bag. In one embodiment of the invention, the speaker system 100 is self contained and the components are not accessible from inside of the utility bag 170, and also do not take up any space inside of the utility bag 170. In another example, the speaker system 100 is maintained within a pocket or covering that is accessible from opening the pocket or removing the covering via a zipper, snaps, hook and loop fasteners, etc. In this example, the speaker system 100 may be hidden from view r protected from sunlight, rain, wind, dust, etc. In another example, the speaker system 100 includes dust covers over each speaker to protect the speakers from dust and sunlight. In still another example, the speakers are concealed within a layer of material of the utility bag 170 with sound played through the speaker system passing through the material.

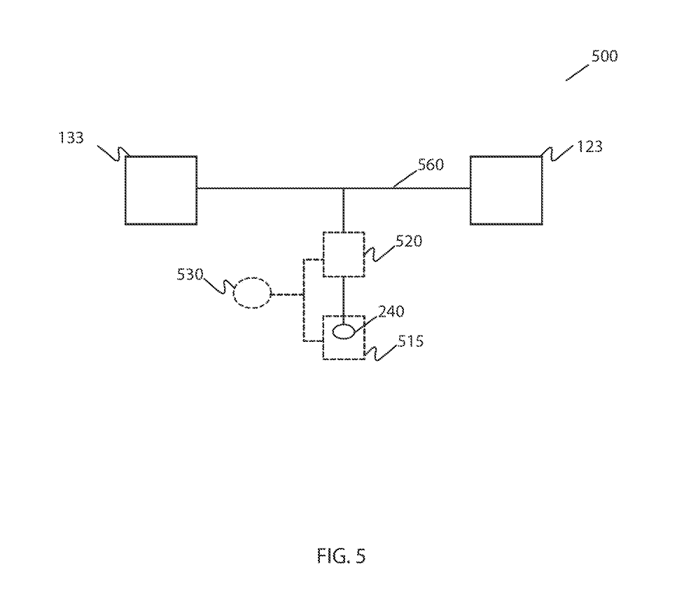

FIG. 2 illustrates the utility bag 170 and speaker system 100 of FIG. 1 shown with the protective cover 150 in an opened state according to one embodiment of the invention. In one embodiment of the invention, the audio device placement portion 160 includes a first gap/slot 220 and a second gap/slot 230. In one example, the first slot 220 and the second slot 230 provide access for cables, cords, control buttons, switches, etc. of an audio device placed in the audio device placement portion 210. In one embodiment of the invention, the audio device placement portion 210 includes an audio jack connector 240 for attaching an audio jack, USB connector, etc. from an audio device to the speaker system 100. In one example, the audio jack connector 240 is attached to a wiring harness 560 (FIG. 5) that attaches to the speakers 123, 133 for playing audio signals. In one example, the speakers 123, 133 are powered through an attached audio device.

In one embodiment of the invention, the audio device placement portion 210 may include a portion 205 that acts as a window and allows light to enter to the inner portion of the utility bag 170. In one example, the portion 205 includes a plastic, Poly(methyl methacrylate) (PMMA), or other equivalent or similar material that allows light to pass through to the interior of the utility bag 170. In another example, the portion 205 comprises a through-hole to the interior of the utility bag 170 without a cover and may include a removable window.

In another example, the portion 205 includes a light source (e.g., light emitting diode(s)) that is powered either separately (i.e., a battery, external power supply, solar charging system, etc.) or via a connected audio device. In another example, the portion 205 is a recess sized smaller than the whole audio device placement portion 210 for particular smaller audio devices.

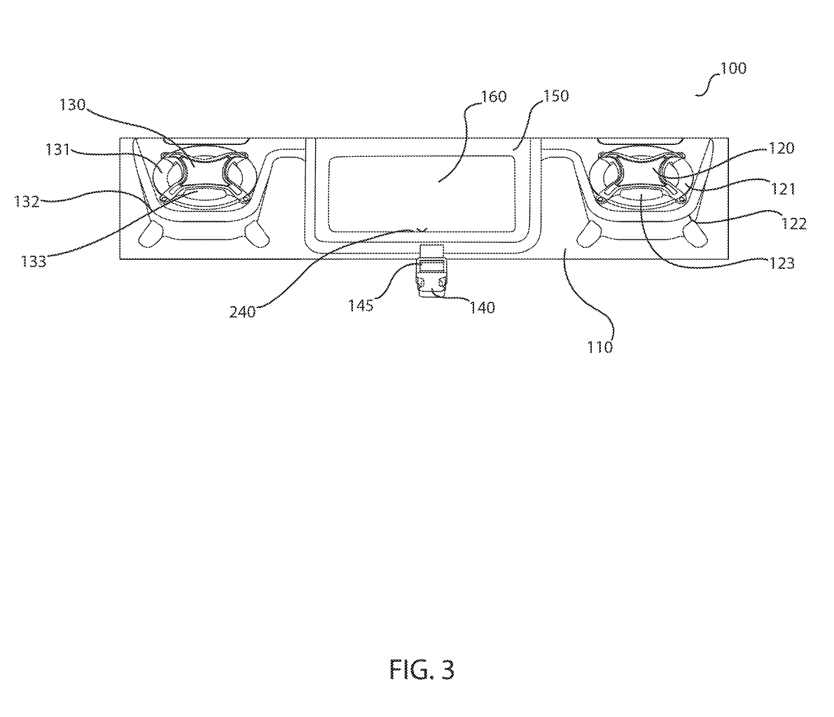

FIG. 3 illustrates a front view of the speaker system 100 for a utility bag according to one embodiment of the invention. As shown, in one example the speaker system 100 is self-contained or integrated into the platform 110. In one example, the platform 110 may be attached to a utility bag, such as utility bag 170 shown in FIG. 1, via thru-holes using means such as rivets, screws, nuts/bolts, or other similar means for attaching. In other examples, the platform 110 may be attached to a utility bag via stitching, heat welding, chemical welding (e.g., adhesives), an attached bracket, etc.

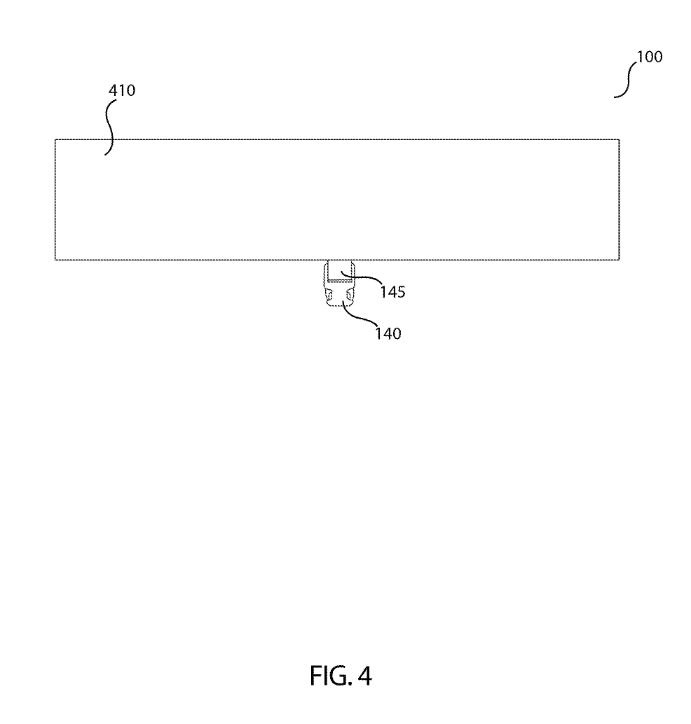

FIG. 4 illustrates a bottom side 410 of platform 110 of the speaker system 100 for a utility bag according to one embodiment of the invention. In another example, the platform 110 may be removable from a utility bag, such as utility bag 170. In this example, the removable platform 110 may be placed appropriately where desired or intentionally left off of a utility bag when desired.

In one embodiment of the invention, the speaker system 100 may be provided as a kit to be attached to an existing utility bag, such as utility bag 170. In one example, the speaker system 100 includes a bracket (not shown) and is attached to an existing utility bag via pre-drilled thru-holes (not shown) or drilled through-holes and secured using means such as rivets, screws, nuts/bolts, or other similar means for attaching. In one example, the user may attach the speaker system 100 to any suitable portion of the existing utility bag.

FIG. 5 illustrates a circuit 500 for the speaker system 100 for a utility bag according to one embodiment of the invention. In one embodiment of the invention, the circuit 500 for the speaker system 100 includes audio jack 240, wiring harness 560 and speakers 123 and 133. In one embodiment of the invention, the wiring harness 560 includes wires connecting the audio jack 240 to each speaker 123, 133 for left and right channels.

In one embodiment of the invention, the circuit 500 includes an additional power source 530 and may include an optional wireless receiver 515 and optional amplifier 520. In one example, if the optional wireless receiver is employed, the speaker system 100 may receive audio signals wirelessly (e.g., Bluetooth®) via an audio device. In this example the audio device is not connected to the audio jack 240. The wireless receiver is powered via the additional power source 530. In one example, the optional amplifier 520 amplifies the signals from the connected audio device and is powered by the additional power source 530.

In one embodiment of the invention, the additional power source 530 may comprise rechargeable or non-rechargeable batteries. In one example, a solar charging circuit is employed to store energy in a rechargeable battery of power source 530. In one example, the solar charging circuit may be disposed on the outer portion of a utility bag 170. In another example, an adapter or plug in socket may be employed with the circuit 500 to connect to an external power source, such as a battery pack from an electric tool (e.g., electric drill, hammer, screwdriver, etc.), separate additional battery pack, an AC/DC power supply, USB, etc.

In one embodiment of the invention, the speaker system 100 may vary in size. In one example, length of the speaker system 100 may range in width from 10 inches to 24 inches, preferably between 12 inches-18 inches; and the width of the speaker system 100 may range from 4 inches-10 inches, preferably between 5 inches-8 inches. It should be noted that the speaker system 100 may be customized and fit according to necessity and desire of the user, and based on the width and length of the utility bag used (e.g., utility bag 170).

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A utility bag comprising:
an audio plug receiving portion;
a pair of speakers coupled with the audio plug receiving portion; and
an audio device placement portion including a protective cover.

2. The utility bag of claim 1, wherein the audio device placement portion comprises a first cable slot and a second cable slot.

3. The utility bag of claim 2, wherein the audio placement portion comprises a recessed portion sized to hold an audio device.

4. The utility bag of claim 3, wherein the protective cover removably couples to the audio placement portion.

5. The utility bag of claim 4, wherein the protective cover includes a fastener that removably couples to a portion of the utility bag.

6. The utility bag of claim 1, wherein each speaker of the pair of speakers comprising:
a mounting platform;
an outer coupling portion; and
a protection guard portion.

7. The utility bag of claim 1, wherein the pair of speakers and the audio device placement portion are integrated into a platform, and the platform is mounted to one side of the utility bag.

8. The utility bag of claim 7, further comprising an amplifier coupled to the pair of speakers.

9. The utility bag of claim 8, further comprising a wireless receiver coupled to the pair of speakers.

10. The utility bag of claim 7, wherein pair of speakers are water resistant.

11. A speaker system for a utility bag comprising:
a mounting platform including:
an audio plug receiving portion;
a pair of speakers coupled with the audio plug receiving portion; and
an audio device placement portion including a protective cover.

12. The speaker system of claim 11, wherein the audio device placement portion comprises at least one cable slot.

13. The speaker system of claim 12, wherein the audio placement portion comprises a recessed portion sized to hold an audio device.

14. The speaker system of claim 13, wherein the protective cover removably couples to the audio placement portion.

15. The speaker system of claim 14, wherein the protective cover includes a fastener that removably couples to a fastener receiver.

16. The speaker system of claim 1, wherein each speaker of the pair of speakers comprising:
a mounting platform;
an outer coupling portion; and
a protection guard portion.

17. The speaker system of claim 1, wherein the platform is mounted to one side of a utility bag.

18. A tool bag comprising:
a zipper coupled to a first side and a second side of the tool bag;
an integrated speaker system coupled to the first side of the tool bag, the speaker system comprising a self contained platform including:
an audio plug receiving portion;
a pair of speakers coupled to the audio plug receiving portion; and
an audio device placement portion including a protective cover.

19. The tool bag of claim 18, wherein the protective cover removably couples to the audio placement portion, and the protective cover includes a fastener that removably couples to a fastener receiving portion coupled to the first side of the tool bag.

20. The tool bag of claim 18, wherein each speaker of the pair of speakers comprising:
a mounting platform;
an outer coupling portion; and
a protection guard portion.
